(19) United States
(12) Patent Application Publication
(10) Pub. No.: US 2026/0056278 A1
(43) Pub. Date: Feb. 26, 2026

(54) SYSTEMS, PROGRAM PRODUCTS, AND METHODS FOR AUGMENTING TRACKING OF DRIVER VEHICLES

(71) Applicant: Torc Robotics, Inc., Blacksburg, VA (US)

(72) Inventors: Pablo Smith, Spicewood, TX (US); William Gray Davis, Austin, TX (US); Akshay Pai Raikar, Austin, TX (US); Joseph R. Fox-Rabinovitz, Austin, TX (US)

(21) Appl. No.: 18/810,000

(22) Filed: Aug. 20, 2024

(51) Int. Cl. G01S 5/02; B60W 60/00; H04W 4/48

(52) U.S. Cl. CPC G01S 5/0268; B60W 60/001; H04W 4/48

(57) ABSTRACT

Systems for augmenting the tracking of driver vehicles are disclosed. The systems include a plurality of sensors positioned on an autonomous vehicle, and a radio frequency receiver(s) positioned on the autonomous vehicle. The system also includes a computing system(s) in electronic communication with the plurality of sensors and the radio frequency receiver(s). The computing system(s) is configured to augment tracking of a driver vehicle by performing processes including detecting object data for the driver vehicle, and receiving at least one radio frequency signal from the driver vehicle(s) and/or an electronic device(s). The process also includes determining drive characteristics relating to the received radio frequency signal(s) and determining if the received radio frequency signal(s) is associated with the driver vehicle. In response to determining the received radio frequency signal(s) is associated with the driver vehicle, generating a predictive drive pattern for the driver vehicle.

### TECHNICAL FIELD

The field of the disclosure relates generally to tracking driver vehicles and, more specifically, systems, program products, and methods for augmenting the tracking of driver vehicles for an autonomous vehicle by generating a predictive drive pattern for the driver vehicles.

### BACKGROUND OF THE INVENTION

Various systems have been developed for tracking and monitoring vehicles to enhance safety and efficiency on roadways. These systems typically involve the use of sensors and communication devices to gather data about the vehicle's surroundings and interactions with other vehicles. For example, some systems utilize cameras or LiDAR sensors to detect objects, obstacles, and/or other vehicles. Autonomous vehicles utilizes these sensors and the valuable information collected by the sensors for navigational purposes and decision-making procedures.

However, these sensors used to gather data for autonomous vehicles have operational limitations. For example, most sensors are incapable of detecting vehicles that are not readily visible to the sensors. That is, when a first vehicle moves behind a distinct vehicle, such that the distinct vehicle is positioned between the path of the sensor and the first vehicle, most sensors may not be able to detect or visible identify the first vehicle, as it has become occluded by the distinct vehicle. This sometimes creates scenarios during operation where not all vehicles within the detectable or desirably monitored vicinity of the autonomous vehicle are actually detected. This results in an increased chance for unsafe travel conditions for the autonomous vehicle and/or the undetected vehicle.

This section is intended to introduce the reader to various aspects of art that may be related to various aspects of the present disclosure described or claimed below. This description is believed to be helpful in providing the reader with background information to facilitate a better understanding of the various aspects of the present disclosure. Accordingly, it should be understood that these statements are to be read in this light and not as admissions of prior art.

### SUMMARY OF THE INVENTION

In one aspect, the disclosed provides a system including: a plurality of sensors positioned on an autonomous vehicle; at least one radio frequency receiver positioned on the autonomous vehicle; and at least one autonomous vehicle computing system in electronic communication with the plurality of sensors and the at least one radio frequency receiver, the at least one autonomous vehicle computing system configured to augment tracking of a driver vehicle by performing processes including: detecting object data for the driver vehicle using the plurality of sensors; receiving at least one radio frequency signal from at least one of the driver vehicle or at least one electronic device; determining drive characteristics relating to the at least one received radio frequency signal; determining if the at least one received radio frequency signal is associated with the driver vehicle based on the determined drive characteristics and the detected object data for the driver vehicle; and in response to determining the at least one received radio frequency signal is associated with the driver vehicle, generating a predictive drive pattern for the driver vehicle based on the detected object data and the determined drive characteristics relating to the at least one received radio frequency signal.

In another aspect, the disclosed provides a computer program product stored on a non-transitory computer-readable storage medium, which when executed by a computing system, augments tracking of a driver vehicle. The computer program product includes program code for: detecting object data for the driver vehicle using a plurality of sensors positioned on an autonomous vehicle; receiving at least one radio frequency signal from at least one of the driver vehicle or at least one electronic device by at least one radio frequency receiver positioned on the autonomous vehicle; determining drive characteristics relating to the at least one received radio frequency signal; determining if the at least one received radio frequency signal is associated with the driver vehicle based on the determined drive characteristics and the detected object data for the driver vehicle; and in response to determining the at least one received radio frequency signal is associated with the driver vehicle, generating a predictive drive pattern for the driver vehicle based on the detected object data and the determined drive characteristics relating to the at least one received radio frequency signal.

In yet another aspect, the disclosed provides a method for augmenting tracking of a driver vehicle. The method including: detecting object data for the driver vehicle using a plurality of sensors positioned on an autonomous vehicle; receiving at least one radio frequency signal from at least one of the driver vehicle or at least one electronic device by at least one radio frequency receiver positioned on the autonomous vehicle; determining drive characteristics relating to the at least one received radio frequency signal; determining if the at least one received radio frequency signal is associated with the driver vehicle based on the determined drive characteristics and the detected object data for the driver vehicle; and in response to determining the at least one received radio frequency signal is associated with the driver vehicle, generating a predictive drive pattern for the driver vehicle based on the detected object data and the determined drive characteristics relating to the at least one received radio frequency signal.

Various refinements exist of the features noted in relation to the above-mentioned aspects. Further features may also be incorporated in the above-mentioned aspects as well. These refinements and additional features may exist individually or in any combination. For instance, various features discussed below in relation to any of the illustrated examples may be incorporated into any of the above-described aspects, alone or in any combination.

### BRIEF DESCRIPTION OF DRAWINGS

The following drawings form part of the present specification and are included to further demonstrate certain aspects of the present disclosure. The disclosure may be better understood by reference to one or more of these drawings in combination with the detailed description of specific embodiments presented herein.

FIG. 1 is a schematic diagram of an autonomous vehicle;

FIG. 2 is a block diagram of an autonomous vehicle;

FIGS. 3A-3E are ariel views of an autonomous vehicle and driver vehicles traveling on a road;

FIG. 4 is an ariel view of an autonomous vehicle and driver vehicles traveling on a road;

FIG. 5 is a flowchart showing a process for augmenting tracking of driver vehicles; and

FIG. 6 is a block diagram of an example computing device.

Corresponding reference characters indicate corresponding parts throughout the several views of the drawings. Although specific features of various examples may be shown in some drawings and not in others, this is for convenience only. Any feature of any drawing may be referenced or claimed in combination with any feature of any other drawing. The drawings are not to scale unless otherwise noted.

### DETAILED DESCRIPTION

The following detailed description and examples set forth preferred materials, components, and procedures used in accordance with the present disclosure. This description and these examples, however, are provided by way of illustration only, and nothing therein shall be deemed to be a limitation upon the overall scope of the present disclosure.

The disclosed systems and methods are described, for clarity, using certain terminology when referring to and describing relevant components within the disclosure. Where possible, common industry terminology is employed in a manner consistent with its accepted meaning. Unless otherwise stated, such terminology should be given a broad interpretation consistent with the context of the present application and the scope of the appended claims.

Autonomous vehicles discussed herein provide improved augmentation of the tracking of driver vehicles for an autonomous vehicle by generating a predictive drive pattern for the driver vehicles. The generated predictive drive pattern is based on, at least in part, received radio frequency signals that are emitted by driver vehicles themselves, and/or electronic devices (e.g., cellphones, laptops) included within the driver vehicles during operation. These predictive drive patterns may also be generated for vehicles even when the vehicles become occluded and/or not detectable by sensors on the autonomous vehicle. The inclusion of these features improve the safety and driver vehicle detection for autonomous vehicles during operation, allow the autonomous vehicle to monitor and/or estimate a position of an occluded vehicle that would otherwise be undetectable, and/or reduce processing power or requirements by an internal computing system of the autonomous vehicle while maintaining the ability to track driver vehicles while they are temporarily occluded or not detectable by sensors of the autonomous vehicle.

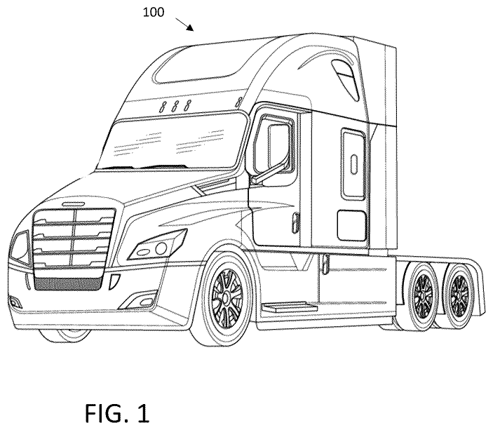

As discussed herein, the disclosure relates generally to tracking driver vehicles and, more specifically, systems, program products, and methods for augmenting the tracking of driver vehicles for an autonomous vehicle by generating a predictive drive pattern for the driver vehicles. These and other examples are discussed below with reference to FIGS. 1-6.

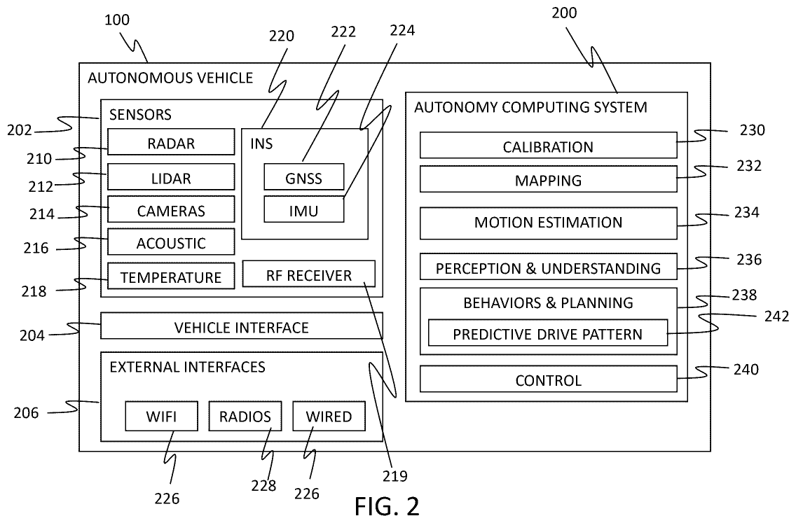

FIG. 1 is a schematic diagram of an autonomous vehicle 100. FIG. 2 is a block diagram of autonomous vehicle 100 shown in FIG. 1. In the example embodiment, autonomous vehicle 100 includes autonomy computing system 200, sensors 202, a vehicle interface 204, and external interfaces 206.

In the example embodiment, sensors 202 may include various sensors such as, for example, radio detection and ranging (RADAR) sensors 210, light detection and ranging (LiDAR) sensors 212, cameras 214, acoustic sensors 216, temperature sensors 218, or inertial navigation system (INS) 220, which may include one or more global navigation satellite system (GNSS) receivers 222 and one or more inertial measurement units (IMU) 224. Other sensors 202 not shown in FIG. 2 may include, for example, acoustic (e.g., ultrasound), internal vehicle sensors, meteorological sensors, or other types of sensors. Sensors 202 generate respective output signals based on detected physical conditions of autonomous vehicle 100 and its proximity. As described in further detail below, these signals may be used by autonomy computing system 200 to determine how to control operation of autonomous vehicle 100.

Cameras 214 are configured to capture images of the environment surrounding autonomous vehicle 100 in any aspect or field of view (FOV). The FOV can have any angle or aspect such that images of the areas ahead of, to the side, behind, above, or below autonomous vehicle 100 may be captured. In some embodiments, the FOV may be limited to particular areas around autonomous vehicle 100 (e.g., forward of autonomous vehicle 100, to the sides of autonomous vehicle 100, etc.) or may surround 360 degrees of autonomous vehicle 100. In some embodiments, autonomous vehicle 100 includes multiple cameras 214, and the images from each of the multiple cameras 214 may be stitched or combined to generate a visual representation of the multiple cameras'FOVs, which may be used to, for example, generate a bird's eye view of the environment surrounding autonomous vehicle 100. In some embodiments, the image data generated by cameras 214 may be sent to autonomy computing system 200 or other aspects of autonomous vehicle 100, and this image data may include autonomous vehicle 100 or a generated representation of autonomous vehicle 100. In some embodiments, one or more systems or components of autonomy computing system 200 may overlay labels to the features depicted in the image data, such as on a raster layer or other semantic layer of a high-definition (HD) map.

LiDAR sensors 212 generally include a laser generator and a detector that send and receive a LiDAR signal such that LiDAR point clouds (or “LiDAR images”) of the areas ahead of, to the side, behind, above, or below autonomous vehicle 100 can be captured and represented in the LiDAR point clouds. Radar sensors 210 may include short-range RADAR (SRR), mid-range RADAR (MRR), long-range RADAR (LRR), or ground-penetrating RADAR (GPR). One or more sensors may emit radio waves, and a processor may process received reflected data (e.g., raw radar sensor data) from the emitted radio waves. In some embodiments, the system inputs from cameras 214, radar sensors 210, or LiDAR sensors 212 may be fused or used in combination to determine conditions (e.g., locations of other objects) around autonomous vehicle 100.

Autonomous vehicle 100 can also include at least one radio frequency (RF) receiver 219. In non-limiting examples, autonomous vehicle 100 includes a single RF receiver 219, or alternatively a plurality of RF receivers 219, formed as a directional radio frequency receiver array. RF receiver(s) 219 included on autonomous vehicle 100 are formed from any suitable radio frequency receiver or device capable of passively receiving radio frequency (RF) signals during operation of autonomous vehicle 100, as discussed herein. For example, receiver 219 can include, but are not limited to, RF receiver circuits, VHF radio circuits, VLF receiver circuits, regenerative receivers, direct conversion receivers, tuned radio frequency receivers, and the like.

GNSS receiver 222 is positioned on autonomous vehicle 100 and may be configured to determine a location of autonomous vehicle 100, which it may embody as GNSS data, as described herein. GNSS receiver 222 may be configured to receive one or more signals from a global navigation satellite system (e.g., Global Positioning System (GPS) constellation) to localize autonomous vehicle 100 via geolocation. In some embodiments, GNSS receiver 222 may provide an input to or be configured to interact with, update, or otherwise utilize one or more digital maps, such as an HD map (e.g., in a raster layer or other semantic map). In some embodiments, GNSS receiver 222 may provide direct velocity measurement via inspection of the Doppler effect on the signal carrier wave. Multiple GNSS receivers 222 may also provide direct measurements of the orientation of autonomous vehicle 100. For example, with two GNSS receivers 222, two attitude angles (e.g., roll and yaw) may be measured or determined. In some embodiments, autonomous vehicle 100 is configured to receive updates from an external network (e.g., a cellular network). The updates may include one or more of position data (e.g., serving as an alternative or supplement to GNSS data), speed/direction data, orientation or attitude data, traffic data, weather data, or other types of data about autonomous vehicle 100 and its environment.

IMU 224 is a micro-electrical-mechanical (MEMS) device that measures and reports one or more features regarding the motion of autonomous vehicle 100, although other implementations are contemplated, such as mechanical, fiber-optic gyro (FOG), or FOG-on-chip (SiFOG) devices. IMU 224 may measure an acceleration, angular rate, and or an orientation of autonomous vehicle 100 or one or more of its individual components using a combination of accelerometers, gyroscopes, or magnetometers. IMU 224 may detect linear acceleration using one or more accelerometers and rotational rate using one or more gyroscopes and attitude information from one or more magnetometers. In some embodiments, IMU 224 may be communicatively coupled to one or more other systems, for example, GNSS receiver 222 and may provide input to and receive output from GNSS receiver 222 such that autonomy computing system 200 is able to determine the motive characteristics (acceleration, speed/direction, orientation/attitude, etc.) of autonomous vehicle 100.

In the example embodiment, autonomy computing system 200 employs vehicle interface 204 to send commands to the various aspects of autonomous vehicle 100 that actually control the motion of autonomous vehicle 100 (e.g., engine, throttle, steering wheel, brakes, etc.) and to receive input data from one or more sensors 202 (e.g., internal sensors). External interfaces 206 are configured to enable autonomous vehicle 100 to communicate with an external network via, for example, a wired or wireless connection, such as Wi-Fi 226 or other radios 228. In embodiments including a wireless connection, the connection may be a wireless communication signal (e.g., Wi-Fi, cellular, LTE, 5g, Bluetooth, etc.).

In some embodiments, external interfaces 206 may be configured to communicate with an external network via a wired connection 226, such as, for example, during testing of autonomous vehicle 100 or when downloading mission data after completion of a trip. The connection(s) may be used to download and install various lines of code in the form of digital files (e.g., HD maps), executable programs (e.g., navigation programs), and other computer-readable code that may be used by autonomous vehicle 100 to navigate or otherwise operate, either autonomously or semi-autonomously. The digital files, executable programs, and other computer readable code may be stored locally or remotely and may be routinely updated (e.g., automatically or manually) via external interfaces 206 or updated on demand. In some embodiments, autonomous vehicle 100 may deploy with all of the data it needs to complete a mission (e.g., perception, localization, and mission planning) and may not utilize a wireless connection or other connection while underway.

In the example embodiment, autonomy computing system 200 is implemented by one or more processors and memory devices of autonomous vehicle 100. Autonomy computing system 200 includes modules, which may be hardware components (e.g., processors or other circuits) or software components (e.g., computer applications or processes executable by autonomy computing system 200), configured to generate outputs, such as control signals, based on inputs received from, for example, sensors 202. These modules may include, for example, a calibration module 230, a mapping module 232, a motion estimation module 234, a perception and understanding module 236, a behaviors and planning module 238, a control module or controller 240, and predictive drive pattern module 242. Predictive drive pattern module 242, for example, may be embodied within another module, such as behaviors and planning module 238, or separately. These modules may be implemented in dedicated hardware such as, for example, an application specific integrated circuit (ASIC), field programmable gate array (FPGA), or microprocessor, or implemented as executable software modules, or firmware, written to memory and executed on one or more processors onboard autonomous vehicle 100.

Predictive drive pattern module 242 facilitates the augmentation of tracking drive vehicle(s) during operation of autonomous vehicle 100. More specifically, predictive drive pattern module 242 utilizes detected object data from sensors 202 (e.g., images from cameras 214, calculated distances from LiDAR sensors 212, etc.), as well as receiver radio frequency (RF) signal(s) from RF receiver 219, to generate predictive drive patterns for driver vehicles associated with the detected object data and/or RF signal(s). As discussed herein, the generated predictive drive patterns may be especially beneficial to autonomy computing system 200 and autonomous vehicle 100 during operation, where the generated predictive drive pattern is associated with a driver vehicle that has become occluded from view of sensors 202 and/or object data is no longer able to be detected. Additionally, autonomy computing system 200 of autonomous vehicle 100 can utilize the predictive drive pattern generated by predictive drive pattern module 242 to anticipate and/or calculate when the occluded driver vehicle may become detectable again by sensors 202. As such, once the occluded driver vehicle is once again visible and/or detectable by sensors 202, autonomy computing system 200 can instantaneously and/or with minimal additional processing steps or demand, (re)identify the previously occluded driver vehicle and continue detecting object data.

Autonomy computing system 200 of autonomous vehicle 100 may be completely autonomous (fully autonomous) or semi-autonomous. In one example, autonomy computing system 200 can operate under Level 5 autonomy (e.g., full driving automation), Level 4 autonomy (e.g., high driving automation), or Level 3 autonomy (e.g., conditional driving automation). As used herein the term “autonomous” includes both fully autonomous and semi-autonomous.

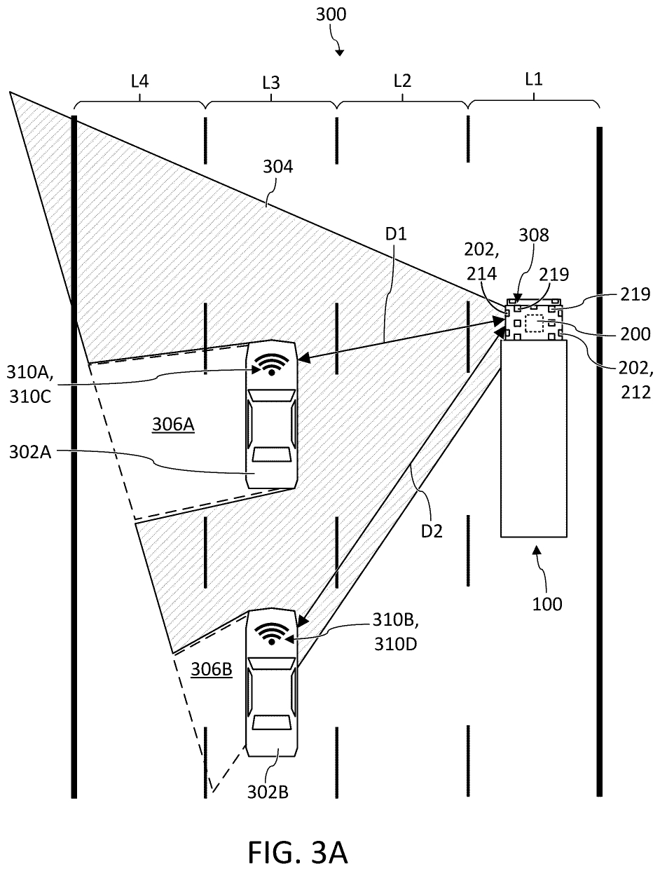

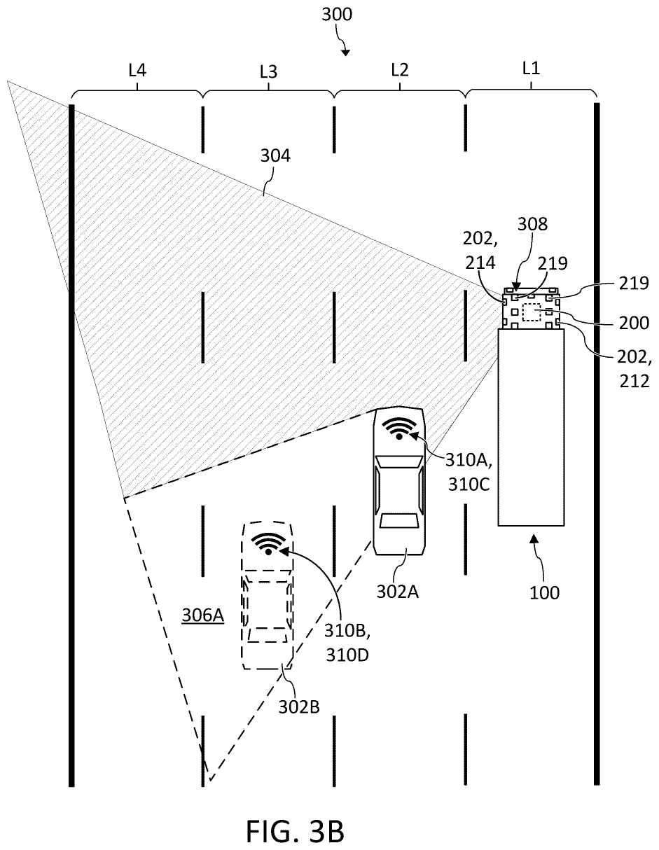

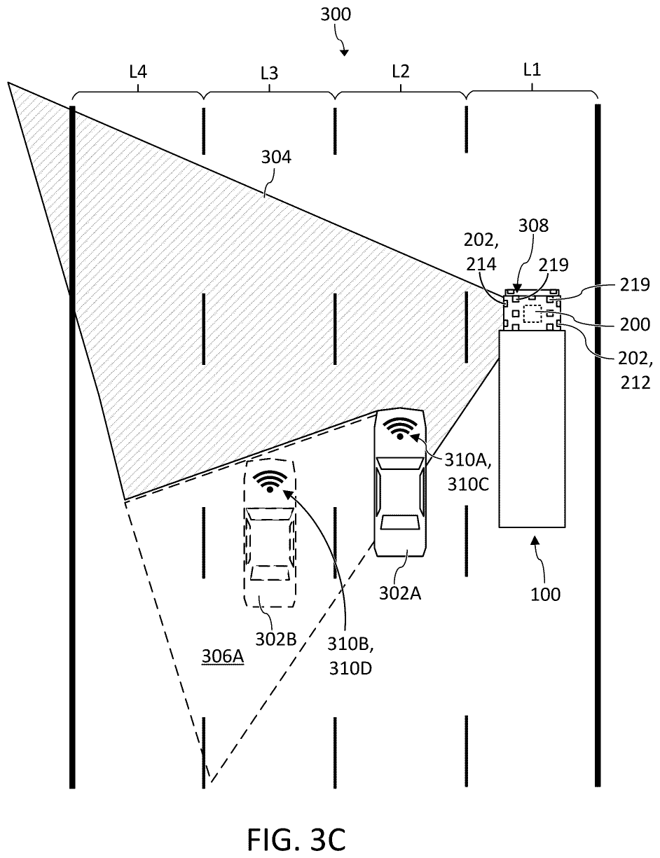

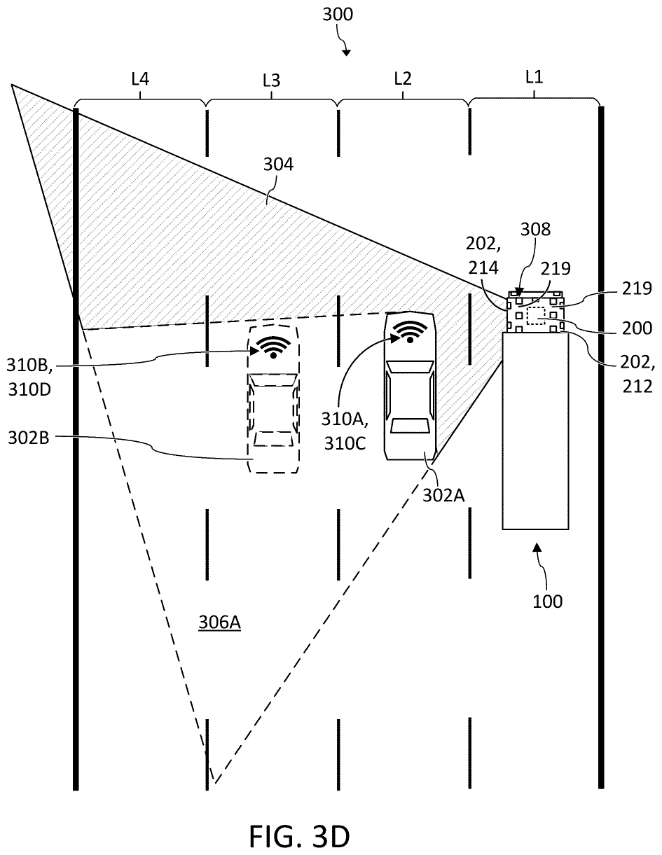

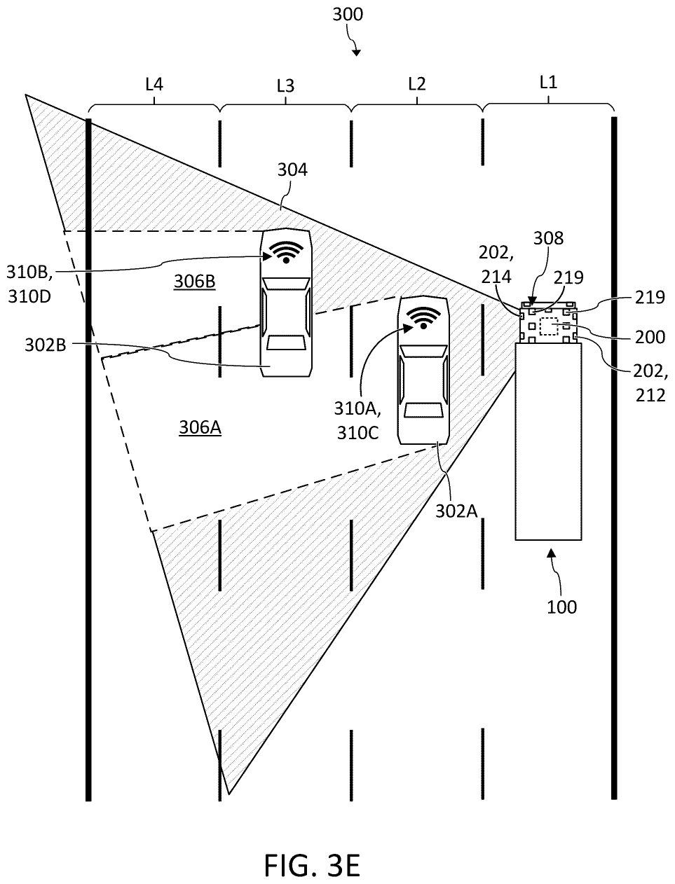

FIG. 3A is an aerial view of a portion of a road 300 including at least one driver vehicle 302A, 302B and autonomous vehicle 100. In the example, road 300 includes a first lane (L1), a second lane (L2) formed adjacent first lane (L1), a third lane (L3) formed adjacent second lane (L2), and a fourth lane (L4) formed adjacent third lane (L3) and opposite first lane (L1). As shown, driver vehicles 302A, 302B are traveling in the third lane (L3) of road 300, where driver vehicle 302A is ahead of and/or traveling in front of driver vehicle 302B. In the non-limiting example shown in FIG. 3A, driver vehicles 302A, 302B are passenger cars or vehicles that are piloted or controlled by a driver. In other non-limiting examples, driver vehicles 302A, 302B can include any road-approved vehicle including motorcycles, box-trucks, tractor-trailers, and the like. Additionally, although discussed herein as being controlled by a driver, it is understood that driver vehicles 302A, 302B can include an autonomous vehicle as well.

Autonomous vehicle 100 is traveling along road 300 within the first lane (L1), adjacent the second lane (L2) and driver vehicles 302A, 302B. In a non-limiting example, autonomous vehicle 100 is an autonomous or self-driving vehicle (e.g., autonomous cargo truck), as similarly discussed herein with respect to FIGS. 1 and 2. As shown in FIG. 3A, autonomous vehicle 100 is in front of both driver vehicles 302A, 302B.

As shown in FIG. 3A, autonomous vehicle 100 includes at least one autonomy computing system 200, as discussed herein with respect to FIG. 2. The at least one computing system 200 is electronically coupled and/or communicatively connected to various systems and/or components of autonomous vehicle 100. For example, and as discussed herein, autonomous vehicle 100 includes and/or is in electronic communication with at least one sensor 202. In the non-limiting example, autonomous vehicle 100 includes a plurality of sensors 202 positioned around and/or disposed on various portions of autonomous vehicle 100. As shown in the example in FIG. 3A, sensors 202 are disposed on, positioned on, and/or coupled to an exterior of autonomous vehicle 100, adjacent to a front end of autonomous vehicle 100. In other non-limiting examples, sensors 202 can also be positioned adjacent a back end of autonomous vehicle 100 as well. The plurality of sensors 202 included on autonomous vehicle 100 are utilized in conjunction with an advanced driver assistance system (ADAS) and/or computing system 200 of autonomous vehicle 100. That is, sensors 202 obtain, gather, and/or receive data regarding surrounding driver vehicles 302A, 302B and/or objects positioned adjacent autonomous vehicle 100 as autonomous vehicle 100 travels along road 300. The object data obtained and/or detected by sensors 202 are processed by the ADAS and/or computing system 200 and is utilized to facilitate the augmentation of driving patterns for driver vehicles 302A, 302B, as discussed herein. As similarly discussed herein, sensors 202 are configured or formed as a variety of sensors including, but not limited to, radar sensors 210, LiDAR sensors 212, cameras 214, acoustic sensors 216, and/or temperature sensors 218.

Sensors 202 of autonomous vehicle 100, at least in part, define a predetermined detection area or vicinity 304 of autonomous vehicle 100. Predetermined detection vicinity 304 is an area adjacent to and/or surrounding autonomous vehicle 100 in which sensors 202 can obtain or detect object data about driver vehicles 302A, 302B and/or objects adjacent road 300. The size of predetermined detection vicinity 304 is dependent, at least in part on, the types of sensors 202, the number of sensors 202, and/or the position or placement of sensors 202 on autonomous vehicle 100. As discussed herein, the detection of object data specific to each driver vehicle 302A, 302B, as detected within the predetermined detection vicinity 304 of autonomous vehicle 100, facilitate the augmentation of tracking driver vehicles 302A, 302B by autonomous vehicle 100 while traveling on road 300. Additionally, as shown in FIG. 3A, the detection vicinity 304 can be abbreviated, limited, and/or at least partially occluded based on the position and/or number of driver vehicles 302A, 302B that are driving on road 300. Occluded areas 306 can be formed in detection vicinity 304 as a result of driver vehicles 302A, 302B being positioned on road 300 adjacent autonomous vehicle 100/sensors 202 and within predetermined detection vicinity 304. For example, driver vehicle 302A can define, create, and/or form occluded area 306A adjacent driver vehicle 302A and opposite autonomous vehicle 100. Additionally, driver vehicle 302B forms occluded area 306B within predetermined detection vicinity 304, adjacent driver vehicle 302B and opposite autonomous vehicle 100. As discussed herein, driver vehicle(s) 302A, 302B or objects positioned, aligned, and/or located within occluded areas 306 may not be detected by sensors 202. As a result, object data specific to the driver vehicle(s) 302A, 302B or objects positioned within occluded areas 306 also may not be detected or generated.

Sensors 202 positioned on autonomous vehicle 100 collect, detect, monitor, and/or gather object data for driver vehicles 302A, 302B detected and/or identified within predetermined vicinity 304 of autonomous vehicle 100. The object data detected by sensors 202 is further processed, analyzed, and/or evaluated by autonomy computing system 200 to translate the detected object data into tangible and/or meaningful object data that may be used by autonomy computing system 200 of autonomous vehicle 100 during operation and/or to facilitate augmentation of tracking driver vehicles 302A, 302B. In non-limiting examples, detected and/or processed object data for driver vehicles 302A, 302B can include, but are not limited to, a location of the identified driver vehicle 302A, 302B, a direction of travel for the identified driver vehicle 302A, 302B, a speed/acceleration for driver vehicle 302A, 302B, a size of the identified driver vehicle 302A, 302B, a distance between autonomous vehicle 100 and driver vehicles 302A, 302B, or any other suitable data that is utilized by computing system 200 of autonomous vehicle 100 for facilitating the augmentation of tracking driver vehicles 302A, 302B, as discussed herein.

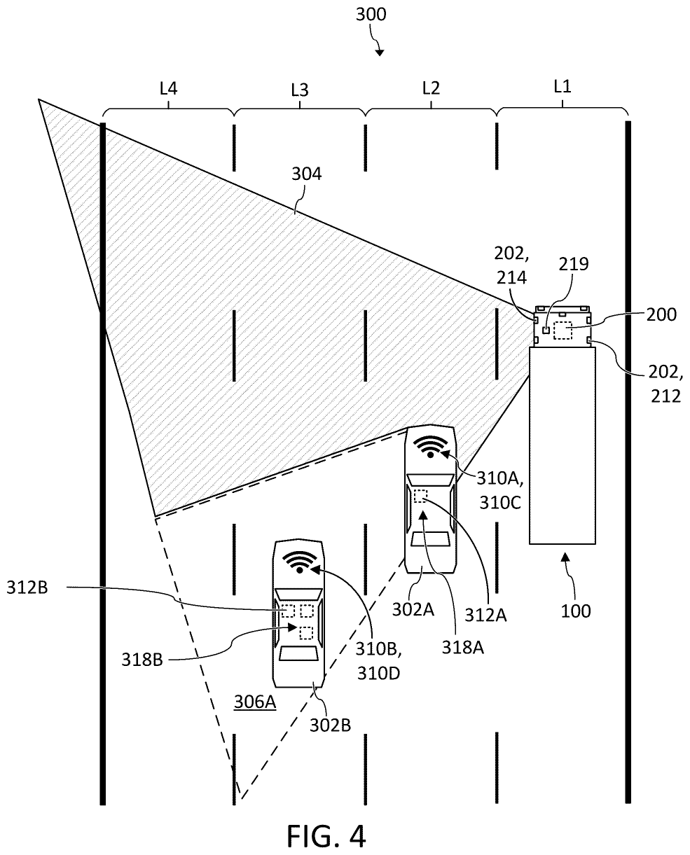

Autonomous vehicle 100 can also include at least one radio frequency (RF) receiver 219 positioned thereon. More specifically, autonomous vehicle 100 includes and/or is in electronic communication with at least one RF receiver 219. In the non-limiting example shown in FIG. 3A, autonomous vehicle 100 includes a plurality of RF receivers 219, formed as a directional radio frequency receiver array 308, positioned around and/or disposed on various portions of autonomous vehicle 100. In the example, RF receivers 219 are disposed on, positioned on, and/or coupled to an exterior of autonomous vehicle 100, adjacent to a front end of autonomous vehicle 100. In other non-limiting examples, RF receivers 219 can also be positioned adjacent a back end or side (e.g., on trailer portion) of autonomous vehicle 100 as well. The plurality of RF receivers 219 included on autonomous vehicle 100 are formed from any suitable radio frequency receiver or device capable of passively receiving radio frequency (RF) signals from driver vehicles 302A, 302B and/or electronic device (see, FIG. 4), as discussed herein. Additionally, as discussed herein, the RF signal(s) received by RF receiver 219 are processed, analyzed, and/or manipulated to determine drive characteristics relating to the RF signals passively received to facilitate the augmentation of tracking driver vehicles 302A, 302B during operation of autonomous vehicle 100.

As discussed herein, driver vehicles 302A, 302B are formed as any suitable road-approved vehicle that may be user driven or autonomous/semi-autonomous in operation. In the non-limiting example shown in FIG. 3A, driver vehicles 302A, 302B can emit at least one radio frequency (RF) signal 310. More specifically, driver vehicle 302A can emit, transmit, and/or radiate at least one RF signal 310A, while driver vehicle 302B emits, transmits, and/or radiates at least one RF signal 310B. The emitted RF signal(s) 310A, 310B for each driver vehicle 302A, 302B can be distinct from one another. That is, in at least some instances, RF signals 310A, 310B are specific to and/or unique for each individual driver vehicle 302A, 302B. For example, a driver vehicle-specific RF signal 310A, 310B can emitted by each of driver vehicle 302A, 302B, where the driver vehicle-specific RF signal is dependent upon, at least in part, the make/model, engine construction, wiring, body-type and/or other operational features of driver vehicles 302A, 302B. More specifically, driver vehicle 302A, formed as a 2015 Honda(R) Civic, may emit a first RF signal 310A, while driver vehicle 302B, formed as a 2023 Ford(R) F-150, may emit a second RF signal 310B that is distinct from the first RF signal 310A of driver vehicle 302A. In other non-limiting examples, RF signal(s) 310A, 310B emitted from driver vehicles 302A, 302B can include, but are not limited to, Bluetooth(R) signals, Wi-Fi signals, and/or any other suitable continuous or semi-continuous RF signal associated with driver vehicle 302A, 302B and/or the systems included therein that can be passively received by RF receiver(s) 219. It is understood that each driver vehicles 302A, 302B can emit one or more RF signals 310A, 310B during operation. As discussed herein, autonomy computing system 200 of autonomous vehicle 100 can receive multiple RF signals 310A, 310B for each driver vehicle 302A, 302B and separate and process each signal to determine drive characteristics for each signal 310A, 310B to facilitate the augmentation of tracking driver vehicles 302A, 302B during operation.

As discussed herein, the terms “passive” or “passively received” can refer to the transmission of RF signals without specific actions of retrieving, calling, and/or actively requesting the RF signals 310. Rather, these RF signals 310 are being continuously or semi-continuously omitted by driver vehicles 302A, 302B. For example, driver vehicle 302A may continuously emit a Bluetooth signal, specific to the systems included within driver vehicle 302A, regardless of whether an electronic device (e.g., cellphone) is connected to the system. That is, driver vehicle 302A may emit the Bluetooth pairing signal continuously, unless a user specifically turns off or disables Bluetooth completely within driver vehicle 302A. Additionally, and as discussed herein, no personal or product identification data is shared or received by RF receiver(s) 219 and/or autonomy computing system 200 of autonomous vehicle 100 during the passive receiving of RF signals 310. Rather, just distinguishable RF properties and/or RF characteristics are detected, determined, and/or received by autonomy computing system 200.

Autonomy computing system 200 of autonomous vehicle 100 facilitates the augmentation of tracking driver vehicles 302A, 302B during operation. For example, and as discussed herein, autonomy computing system 200 is configured to utilize/analyze detected object data and RF signals to generate predictive drive patterns for driver vehicle(s) 302A, 302B on road 300 during operation. The generated predictive drive patterns may augment tracking in instances where driver vehicle(s) 302A, 302B become occluded from sensors 202 and/or when object data for driver vehicles can no longer be detected by sensors 202 during operation. With reference to FIGS. 3A-3E, exemplary processes for augmenting the tracking of driver vehicles 302A, 302B are discussed herein.

The plurality of sensors 202 of autonomous vehicle 100 can detect object data relating to each of driver vehicles 302A, 302B. In a non-limiting example shown in FIG. 3A, sensors 202 can be formed as LiDAR sensors 212 and cameras 214. Object data relating to and/or specific to each driver vehicle 302A, 302B can be generated, determined, and/or calculated based on the continuous detection and/or monitoring achieved by LiDAR sensors 212 and/or cameras 214 of autonomous vehicle 100. As discussed herein, the object data detected by sensors 202 of autonomous vehicle 100 can include, but are not limited to, a location of the identified driver vehicle 302A, 302B, a direction of travel for the identified driver vehicle 302A, 302B, a speed/acceleration for driver vehicle 302A, 302B, a size of the identified driver vehicle 302A, 302B, a separation distance between autonomous vehicle 100 and driver vehicles 302A, 302B, or any other suitable data that is utilized by computing system 200 of autonomous vehicle 100. The detected object data for each driver vehicle can be provided to, analyzed, calculated, and/or determined by autonomy computing system 200 of autonomous vehicle 100.

In the non-limiting example shown in FIG. 3A, sensors 202 (e.g., LiDAR sensors 212, cameras 214) of autonomous vehicle 100 can detect the speed/acceleration, the location on road 300, and the separation distance for each driver vehicle 302A, 302B. More specifically, sensors 202 and/or autonomy computing system 200 can determine that driver vehicle 302A is traveling at a speed of approximately fifty-five (55) miles per hour (mph), while driver vehicle 302B is traveling at a speed of approximately sixty-two (62) mph. Additionally, sensors 202/autonomy computing system 200 can determine both driver vehicles 302A, 302B are traveling in the third lane (L3), and each driver vehicle 302A, 302B is separated from autonomous vehicle 100 by distinct distances (D1, D2). Furthermore, sensors 202/autonomy computing system 200 can identify driver vehicle 302A as a blue Honda Civic, and driver vehicle 302B as a white Ford F-150.

Additionally, the plurality of RF receivers 219 of autonomous vehicle 100 can simultaneously receive RF signal(s) 310A, 310B from driver vehicles 302A, 302B. For example, RF receivers 219, arranged in the directional radio frequency receiver array 308, can passively receive RF signal(s) 310A, 310B from each driver vehicle 302A, 302B including, but not limited to, driver vehicle-specific RF signals, Bluetooth(R) signals, Wi-Fi signals, and/or any other suitable continuous or semi-continuous RF signal associated with driver vehicle 302A, 302B and/or the systems included therein. Continuing the non-limiting example discussed herein, RF receivers 219 can receive first RF signal 310A associated with and/or specific to driver vehicle 302A (e.g., Honda Civic), and second RF signal 310B associated with and/or specific to driver vehicle 302B (e.g., Ford F-150), that is distinct from the first RF signal 310A. Additionally, or alternatively, where each driver vehicle 302A, 302B is Bluetooth(R) enabled, RF receiver 219 can (also) receive RF signal 310C, corresponding to the Bluetooth(R) signal emitted by driver vehicle 302A, and RF signal 310D, corresponding to the Bluetooth(R) signal emitted by driver vehicle 302B.

In the non-limiting example where the plurality of RF receivers 219 (e.g., directional radio frequency receiver array 308) passively receive multiple RF signals 310, each RF signal 310 is separated. That is, the plurality of RF receivers 219 and/or autonomy computing system 200 in operable communication with the plurality of RF receivers 219 may passively receive each of the plurality of RF signals 310A, 310B, 310C, 310D and may determine each RF signal is distinct based on the information, data, and/or type of signal received. As such, each of the distinct RF signals 310A, 310B, 310C, 310D may be separated and processed separately to determine drive characteristics, as discussed herein.

Similar to detected object data, which undergoes analysis and/or processing by autonomy computing system 200, received RF signals 310 also are analyzed, evaluated, and/or computed by autonomy computing system 200 of autonomous vehicle 100. Autonomy computing system 200 can evaluate and/or analyzed to determine drive characteristics relating to each received radio frequency signal 310. In the non-limiting example, where the plurality of RF receivers 219 included on autonomous vehicle 100 receives RF signals 310A, 310C from driver vehicle 302A, and RF signals 310B, 310D from driver vehicle 302B, autonomy computing system 200 can determine drive characteristics relating to each of the plurality of RF signals 310A, 310B, 310C, 310D. That is, autonomy computing system 200 can evaluate or analyze each, separate RF signal 310A, 310B, 310C, 310D received by plurality of RF receivers 219 individually to determine drive characteristics relating to each RF signal. In non-limiting examples, determining drive characteristics for the RF signals 310A, 310B, 310C, 310D can include calculating a position or location of the received RF signals 310A, 310B, 310C, 310D with respect to autonomous vehicle 100, calculating a velocity of the object (e.g., driver vehicles 302A, 302B, electronic device (see, FIG. 4)) emitting or generating RF signals 310A, 310B, 310C, 310D, and/or calculating a distance between the object emitting RF signals 310 and autonomous vehicle 100 based on a determined strength of RF signals 310A, 310B, 310C, 310D received by the plurality of RF receivers 219 on autonomous vehicle 100. In the non-limiting example, autonomy computing system 200 can determine the position/location and/or velocity of RF signals 310 received by the plurality of RF receivers 219 formed as directional radio frequency receiver array 308 using radio direction finding (RDF) or radio-triangulation process. That is, based on the (continuously) measured angle in which RF signals 310 are received by the plurality of RF receivers 219 and/or the timing of the waveform of each RF signal 310 as it's received by each of the plurality of RF receivers 219 of autonomous vehicle 100, autonomy computing system 200 can process the received RF signals 310 and calculate a position/location and/or velocity for each RF signal 310.

Additionally, or alternatively, autonomy computing system 200 can calculate a distance between the object generating or emitting the RF signal(s) 310 based on the signal-to-noise ratio (SNR) for each received RF signal 310. The higher the SNR is for an RF signal, the further away the object is that is emitting the RF signal. In the non-limiting example shown in FIG. 3A, it may be determined that the SNR for RF signals 310B, 310D emitted by driver vehicle 302B are higher than the SNR for RF signals 310A, 310C emitted by driver vehicle 302A because driver vehicle 302A is closer to the plurality of RF receivers 219/autonomous vehicle 100. In another non-limiting example, the SNR for the same RF signal 310 emitted by driver vehicles 302 can be detected and/or monitored over time by RF receiver 219/autonomous vehicle 100. Monitoring the same RF signal 310 over time may indicate or identify whether the driver vehicle 302 emitting the monitored RF signal 310 is moving toward or away from RF receiver 219 based on whether the SNR is increasing and/or decreasing over time.

However, unlike the detected object data, the determined drive characteristics for each RF signal 310 is not immediately associated with specific vehicles 302A, 302B upon receiving RF signals 310 and/or determining of the drive characteristics for each RF signals 310. That is, autonomy computing system 200 cannot automatically associate the determined drive characteristics for each of the plurality of RF signals 310A, 310B, 310C, 310D with specific driver vehicles 302A, 302B traveling on road 300. This is because the received RF signals 310 do not have immediate identifiers and/or easily associable data points where autonomy computing system 200 can determine exactly where each RF signals 310 is originating from. For example, where sensor 202 is formed as a camera 214, autonomy computing system 200 can process the captured photos/videos and immediately associated or identify the vehicle captured in the image as driver vehicle 302A, or driver vehicle 302B.

Conversely, each received RF signal 310 may undergo additional processing and/or weighing by autonomy computing system 200 to determining which RF signals 310A, 310B, 310C, 310D can be associated with driver vehicle 302A or 302B, as discussed herein. That is, subsequent to detecting (and determining) object data for driver vehicles 302A, 302B, and determining drive characteristics relating to each received RF signal 310A, 310B, 310C, 310D, it may be determined if the received signals 310A, 310B, 310C, 310D are associated with driver vehicle 302A or driver vehicle 302B. Autonomy computing system 200 of autonomous vehicle 100 can utilize the object data detected by sensors 202, as well as the determined drive characteristics based on the received RF signals 310A, 310B, 310C, 310D, to determine if the received RF signals 310A, 310B, 310C, 310D are or can be associated with driver vehicle 302A, 302B. For example, the determined drive characteristics for each RF signal 310A, 310B, 310C, 310D can be compared to and/or with similar detected object data for each driver vehicle 302A, 302B. Based on the comparison, autonomy computing system 200 can determine a probability that the object emitting each RF signal 310A, 310B, 310C, 310D is driver vehicle 302A or driver vehicle 302B. In the example where a probability is determined for each of the plurality of RF signals 310A, 310B, 310C, 310D, that probability can then be compared to a predetermined or predefined probability threshold. In the instance where the determined probability is greater than or equal to the probability threshold, autonomy computing system 200 can validate that RF signal 310A, 310B, 310C, 310D having the probability that equals/exceeds the probability threshold is emitted from an object that is either driver vehicle 302A, 302B or is an object that is positioned within a respective driver vehicle 302A, 302B (e.g., electronic device within driver vehicle 302A (see, FIG. 4)). The predefined probability threshold, as determined by autonomy computing system 200, is a threshold that provides a high-likelihood or rate of success that RF signal 310 is associated with a specific driver vehicle 302A, 302B.

As discussed herein, autonomy computing system 200 can analyze and/or process each of the received RF signals 310A, 310B, 310C, 310D and determine drive characteristics for each signal. For example, and based on received RF signal 310A, autonomy computing system 200 can calculate that the object omitting RF signal 310A is approximately a distance two (2) feet less than distance (D1) away from autonomous vehicle 100, and traveling at a speed between approximately fifty-two (52) mph and fifty-eight (58) mph. Analysis of received RF signal 310C may determine, generate, and/or calculate similar drive characteristics as RF signal 310A. That is, autonomy computing system 200 can calculate that the object emitting RF signal 310C is approximately one (1) foot less than the distance (D1) away from autonomous vehicle 100, and traveling at a speed of approximately fifty-three (53) mph. Conversely, autonomy computing system 200 can calculate that the object omitting RF signal 310B is approximately two (2) feet more than the distance (D2) away from autonomous vehicle 100, and traveling at a speed between approximately sixty (60) mph and sixty-five (65) mph. Autonomy computing system 200 can separately calculate the object omitting RF signal 310D is approximately a distance half-way between distance (D1) and distance (D2) from autonomous vehicle 100, and traveling at a speed between approximately fifty-five (55) mph and sixty-two (62) mph.

Having determined the drive characteristics using the received RF signals 310A, 310B, 310C, 310D, and previously detecting object data for driver vehicles 302A, 302B, autonomy computing system 200 can then determine if the received RF signals 310A, 310B, 310C, 310D are associated with driver vehicle 302A or driver vehicle 302B. For example, autonomy computing system 200 can compare the drive characteristics relating to RF signal 310A (e.g., determined distance away from autonomous vehicle 100, and travel speed) with the detected object data (e.g., distance away from autonomous vehicle 100, travel speed) for both driver vehicles 302A, 302B and assign or determine a probability for RF signal 310A in relation to driver vehicle 302A and driver vehicle 302B. Continuing the example, and with reference to FIG. 3A, driver characteristics relating to RF signal 310A include a calculated distance two (2) feet less than distance (D1) away from autonomous vehicle 100 and a travel speed between approximately fifty-two (52) mph and fifty-eight (58) mph. As discussed herein, the object data for driver vehicle 302A includes a distance (D1) from autonomous vehicle 100 and an approximate travel speed of fifty-five (55) mph, while object data for driver vehicle 302B includes a distance (D2) from autonomous vehicle 100 and an approximate travel speed of approximately sixty-two (62) mph. Autonomy computing system 200 can then determine, based on the drive characteristics for RF signal 310A and detect object data for driver vehicle 302A, that the probability that RF signal 310A is emitted from driver vehicle 302A is approximately 91%. Additionally, autonomy computing system 200 can determine, based on the drive characteristics for RF signal 310A and detect object data for driver vehicle 302B, that the probability that RF signal 310A is emitted from driver vehicle 302B is approximately 38%. In an example where the probability threshold for associating and/or validating RF signal 310A with specific driver vehicles 302A, 302B is 85%, autonomy computing system 200 may then associate RF signal 310A with driver vehicle 302A and not driver vehicle 302B.

Autonomy computing system 200 can perform similar processes for associating each RF signal 310B, 310C, 310D. For example, autonomy computing system 200 can compare determined driver characteristics relating to each RF signal 310B, 310C, 310D with detected object data for both driver vehicles 302A, 302B to determine association probabilities for each RF signal 310B, 310C, 310D. Autonomy computing system 200 can then determine if respective association probabilities for RF signals 310B, 310C, 310D are equal to or greater than a probability threshold, and if yes, autonomy computing system 200 can associate and/or validate RF signal 310B, 310C, 310D are likely emitted by one of driver vehicle 302A or driver vehicle 302B. In the exemplary embodiments discussed herein, and as similarly discussed herein with respect to RF signal 310A, autonomy computing system 200 can associate RF signal 310B with driver vehicle 302B and/or can validate that RF signal 310B is likely emitted from driver vehicle 302B. More specifically, where autonomy computing system 200 determines RF signal 310B is not associated with driver vehicle 302A, based on the determined probability and probability threshold, autonomy computing system 200 can compare the determined drive characteristics for RF signal 310B with the distinct, detected object data for driver vehicle 302B. Using the distinct, detected object data for driver vehicle 302B, autonomy computing system 200 can determine a probability of association, compare the determined probability to the probability threshold, and ultimately associate RF signal 310B with driver vehicle 302B and/or validate that RF signal 310B is likely emitted from driver vehicle 302B.

In the exemplary embodiment, autonomy computing system 200 can associate RF signal 310C with driver vehicle 302A and/or validate that RF signal 310C is likely emitted from driver vehicle 302A—similar to RF signal 310A. Furthermore, RF signal 310C includes similar determined drive characteristics (e.g., one (1) foot less than the distance (D1), traveling speed of approximately fifty-three (53) mph) as determined drive characteristics for RF signal 310A (e.g., two (2) feet less than distance (D1), traveling speed of approximately fifty-two (52) mph to fifty-eight (58) mph). In addition to associating and/or validating the RF signals 310A, 310C with respect to driver vehicle 302A, autonomy computing system 200 may also compare determined drive characteristics and validate the associations and/or create arrays of RF signals that are associated with a single driver vehicle 302A. In this example, and after associating RF signal 310C with driver vehicle 302A based on determined probabilities, autonomy computing system 200 may group or establish the array that both RF signals 310A, 310C are (permanently) associated with driver vehicle 302A, while driver vehicle 302A remains in the predetermined detection vicinity 304 of autonomous vehicle 100 during operation.

In the non-limiting example shown in FIG. 3A, and as discussed herein, autonomy computing system 200 may not associate RF signal 310D with either driver vehicles 302A, 302B. More specifically, in comparing the determined drive characteristics for RF signal 310D (e.g., calculated distance half-way between distance (D1) and distance (D2), traveling speed of approximately fifty-five (55) mph and sixty-two (62) mph) to the detected object data of both driver vehicle 302A (e.g., distance (D1), 55 mph) and driver vehicle 302B (e.g., distance (D2), 62 mph), autonomy computing system 200 may determine the probabilities for RF signal 310D is 50% for both driver vehicles 302A, 302B. As such, autonomy computing system 200 cannot associate RF signal 310D with either driver vehicles 302A, 302B and/or cannot validate that RF signal 310D is likely emitted from either driver vehicles 302A, 302B. In non-limiting examples, autonomy computing system 200 can disregard RF signal 310D during future processing, or alternatively, can continue to detect and process RF signal 310D, as similarly discussed herein, until autonomy computing system 200 is able to associate RF signal 310D with one of the two driver vehicles 302A, 302B traveling on road 300.

Associating RF signals 310 with driver vehicles 302A, 302B may aid and/or improve autonomy computing system 200 ability to track driver vehicles 302A, 302B during operation of autonomous vehicle 100. That is, in addition to object data detected by sensors 202, RF signals 310 received by plurality of RF receivers 219 on autonomous vehicle 100 can augment the tracking of driver vehicles 302A, 302B during operation. Additionally, and as discussed herein, utilizing RF signals 310 and associating them with driver vehicles 302A, 302B allows autonomy computing system 200 to continuously track or estimate the position of driver vehicles 302A, 302B that may become occluded or unable to be detected by sensors 202 while traveling on road 300 adjacent 100.

FIGS. 3B-3E are ariel views of road 300 including driver vehicles 302A, 302B in various positions traveling adjacent autonomous vehicle 100. It is understood that similarly numbered and/or named components can function in a substantially similar fashion. Redundant explanation of these components has been omitted for clarity.

As shown in FIG. 3B, driver vehicle 302A has changed lanes and moved from the third lane (L3) (see FIG. 3A) to the second lane (L2), adjacent autonomous vehicle 100 traveling in the first lane (L1). In the exemplary embodiment, driver vehicle 302A may move out of the third lane (L3) as a result of driver vehicle 302B approaching at a higher rate of speed (e.g., 55 mph v. 62 mph). However, because driver vehicle 302A moves closer to autonomous vehicle 100 and sensors 202 formed thereon, and driver vehicle 302B is still behind driver vehicle 302A, driver vehicle 302B may become occluded, not visible, an/or not detectable by autonomous vehicle 100. That is, occluded area 306A formed in predetermined detection vicinity 304 by driver vehicle 302A may change and/or be adjusted as driver vehicle 302A moves into the second lane (L2) of road 300. As a result, driver vehicle 302B may be located and/or positioned within occluded area 306A of predetermined detection vicinity 304. When positioned within occluded area 306A, driver vehicle 302A blocks driver vehicle 302B form sensors 202 of autonomous vehicle 100 and object data for driver vehicle 302B may no longer be detected by sensors 202 and/or processed by autonomy computing system 200. In a non-limiting example, in response to driver vehicle 302B becoming occluded and/or not detectable by sensors 202, sensors 202 may cease to detect object data of driver vehicle 302B. Previously sensed or detected object data for driver vehicle 302B, as discussed herein with respect to FIG. 3A, may remain temporarily stored within autonomy computing system 200 and used to augment the tracking of now occluded driver vehicle 302B during operation. As shown in the non-limiting example of FIG. 3B (and FIGS. 3C and 3D), driver vehicle 302B is shown in phantom to represent that it is no longer detectable or able to be sensed by autonomous vehicle 100, and the components included therein (e.g., sensors 202).

Although object data ceases and/or is no longer able to be detected by sensors 202 of autonomous vehicle 100, autonomous vehicle 100 may still receive RF signals 310 from driver vehicle 302B. That is, although occluded from sensors 202 of autonomous vehicle 100 by driver vehicle 302A, driver vehicle 302B may still transmit and/or emit RF signals 310B, 310D while traveling along road 300. As a result, the plurality of RF receivers 219 of autonomous vehicle 100, arranged in directional radio frequency receiver array 308, may still receive RF signals 310B, 310D from driver vehicle 302B, as well as RF signals 310A, 310C from driver vehicle 302A. Because RF signals 310A, 310B, 310C, 310D are continuously received, autonomy computing system 200 of autonomous vehicle 100 can continuously determine drive characteristics relating to RF signals 310A, 310B, 310C, 310D, as similarly discussed herein.

Continuously receiving RF signals 310B, 310D from driver vehicle 302B and determining drive characteristics allows autonomy computing system 200 to predict the movement or drive patterns of occluded driver vehicle 302B. More specifically, in response to determining the received signal(s) 310B, 310D are associated with driver vehicle 302B, autonomy computing system 200 of autonomous vehicle 100 can generate, create, and/or model a predictive drive pattern for driver vehicle 302B. The generated predictive drive pattern is based on, at least in part, the detected object data of driver vehicle 302B, when driver vehicle 302B was detectable by sensors 202, and the determined drive characteristics relating to received RF signals 310B, 310D.

Continuing the example above, autonomy computing system 200 can utilize the object data detected for driver vehicle 302B (e.g., distance (D2) away from autonomous vehicle 100, traveling speed of approximately sixty-two (62) mph) detected prior to driver vehicle 302B becoming occluded, and compare that with the determined drive characteristics of RF signal 310B to predict the drive pattern of driver vehicle 302B. Additionally, autonomy computing system 200 can utilize data relating to autonomous vehicle 100 to aid in generating the predictive drive pattern for driver vehicle 302B. For example, autonomy computing system 200 may also consider that autonomous vehicle 100 is traveling at a speed of fifty-two (52) mph and remains in the first lane (L1), as driver vehicles 302A, 302B travel on road 300. In the example shown in FIG. 3B, determined drive characteristics relating to RF signal 310B may identify the object emitting RF signal 310B, which autonomy computing system 200 associates as driver vehicle 302B, is approximately one-and-one-half (1.5) feet more than the distance (D2) away from autonomous vehicle 100, and traveling at a speed between approximately sixty-one (61) mph and sixty-three (63) mph. Knowing the determined drive characteristics for RF signal 310B after driver vehicle 302B becomes occluded, and knowing data relating to autonomous vehicle 100, autonomy computing system 200 can generate the predictive drive pattern for driver vehicle 302B to calculate, estimate, and/or assess that driver vehicle 302B is continuing in the third lane (L3) on road 300. Additionally, and in view of the determined drive characteristics for driver vehicle 302B, object data continuously detected for driver vehicle 302A, and data relating to autonomous vehicle 100, autonomy computing system 200 can also determine that driver vehicle 302B is still behind driver vehicle 302A but is at least partially aligned with driver vehicle 302A traveling in the second lane (L2) of road 300.

Although not detectable, occluded from, and/or imperceptible by autonomous vehicle 100, and autonomy computing system 200/sensors 202 included thereon the predictive drive pattern for driver vehicle 302B allows autonomy computing system 200 to continuously monitor and/or estimate the position of driver vehicle 302B. The predictive drive pattern and estimated position of occluded driver vehicle 302B improves the safety and operation of autonomous vehicle 100 by allowing autonomy computing system 200/autonomous vehicle 100 to continuously monitor a vehicle that is undetectable by sensors 202 and/or was previously negated or dismissed by autonomy computing system 200 once the vehicle became undetectable.

FIGS. 3C &3D show driver vehicles 302A, 302B and autonomous vehicle 100 continuing to drive along road 300. With comparison to FIGS. 3A and 3B, driver vehicle 302B, shown in phantom indicating the vehicle is represented as a predictive drive pattern generated by autonomy computing system 200 of autonomous vehicle 100, continues to travel on road 300 in the third lane (L3) and moves closer to passing driver vehicle 302A and autonomous vehicle 100. As similarly discussed herein with respect to FIGS. 3A and 3B, the plurality of RF receivers 219 of autonomous vehicle 100 continuously receive RF signals 310B, 310D emitted from driver vehicle 302B to generate the predictive drive pattern of 302B, while simultaneously detecting driver vehicle 302A and/or object data relating to driver vehicle 302A.

In another exemplary embodiment (not shown), determined drive characteristics relating to RF signals 310B, 310D may allow autonomy computing system 200 to generate predictive drive patterns that differentiate from those shown and discussed herein. For example, autonomy computing system 200 may determine that the distance between driver vehicle 302B emitting RF signal 310B and autonomous vehicle 100 decreases then increases, and the speed simultaneously decreases with the distance. In the example, the predictive drive pattern generated by autonomy computing system 200 may indicate, calculate, and/or estimate that driver vehicle 302B is slowing down within the third lane (L3). Alternatively, it may be determined in some instances that the distance between driver vehicle 302B emitting RF signal 310B and autonomous vehicle 100 decreases then increases, but the speed remains the same. In this non-limiting example, the predictive drive pattern generated by autonomy computing system 200 may indicate, calculate, and/or estimate that driver vehicle 302B is maintaining the same speed but may shift from the third lane (L3) to the fourth lane (L4). Various determined drive characteristics and/or scenarios may allow autonomy computing system 200 of autonomous vehicle 100 to generate the predictive drive patterns for driver vehicle 302B to accurately estimate and/or predict the movement of driver vehicle 302B even when driver vehicle 302B is not detectable and/or visible to autonomous vehicle 100.

Autonomy computing system 200 may continuously receive RF signals 310B, 310D and generate the predictive drive pattern for driver vehicle 302B until driver vehicle 302B is once again detectable by sensors 202 of autonomous vehicle 100. For example, and as shown in FIG. 3E, driver vehicle 302B is positioned in the third lane (L3) of road 300 but has now passed driver vehicle 302A. As such, driver vehicle 302B is no longer occluded from sensors 202. More specifically, once driver vehicle 302B passes or moves in front of driver vehicle 302A, driver vehicle 302B is no longer positioned within occluded area 306A created by driver vehicle 302A, but rather is positioned within predetermined detection vicinity 304 of autonomous vehicle 100. As such, sensors 202 may once again detect object data relating to both driver vehicles 302A, 302B. Additionally, and because autonomy computing system 200 continuously received RF signals 310B, 310D to generate the predictive drive pattern, autonomy computing system 200 may associated, recognize, and/or continuously detect driver vehicle 302B traveling on road 300 immediately after driver vehicle 302B becomes visible or detectable by sensors 202.

FIG. 4 is an aerial view of a portion of a road 300 including at least one driver vehicle 302A, 302B and autonomous vehicle 100. It is understood that similarly numbered and/or named components can function in a substantially similar fashion. Redundant explanation of these components has been omitted for clarity.

As shown in FIG. 4, each driver vehicle 302A, 302B may also include at least one electronic device 312 included therein. More specifically, driver vehicle 302A includes a single electronic device 312A, and driver vehicle 302B includes three electronic device 312B. In the non-limiting example, electronic devices 312A, 312B represent and/or include personal electronic devices that may be owned, carried, and/or used by users (e.g., drivers, passengers) of driver vehicles 302A, 302B. For example, electronic device 312A within driver vehicle 302A may be the driver's smart phone, while electronic devices 312B of driver vehicle 302B can include a driver's smart phone, a first passenger's tablet or smart device, and a second passenger's laptop. Electronic devices 312A, 312B may include any suitable electronic device that may emit a continuous or semi-continuous radio frequency (RF) signal 318A, 318B —similar to RF signals 310 discussed herein. In non-limiting examples, RF signals 318 emitted by electronic device 312A, 312B may include, but are not limited to, Bluetooth(R) signals, Wi-Fi signals, a cellular signal (e.g., 4G/5G), or the like.

It is understood that the number of electronic devices 312A, 312B shown and discussed herein with respect to FIG. 4 is exemplary. As such, driver vehicles 302A, 302B can include more or less electronic devices 312A, 312B. Additionally, the types of RF signals 318A, 318B is also exemplary. Electronic devices 312A, 312B can emit distinct RF signals than those discussed herein and/or each electronic device 312A, 312B can emit more than one RF signal 318A, 318B at a time.

As similarly discussed herein with respect to RF signals 310A, 310B, 310C, 310D emitted by driver vehicles 302A, 302B, and used in conjunction, RF signals 318A, 318B can be received by RF receiver 219, and drive characteristics for each RF signal 318A, 318B can be determined. Determined drive characteristics for RF signals 318A, 318B aid in associating RF signals 318A, 318B with each driver vehicle 302A, 302B, and ultimately with generating predictive drive patterns for driver vehicles 302A, 302B, should it become occluded. In the non-limiting example where driver vehicles 302A, 302B include multiple electronic devices (e.g., driver vehicle 302B including three (3) electronic device 312B), determined drive characteristics for each RF signal 318B emitted by electronic devices 312B may be compared to one another (and detected object data) to create an array of RF signals 318B. As similarly discussed herein with respect to RF signals 310A, 310C, the array of RF signals 318B having substantially similar determined drive characteristics may all be associated with single driver vehicle 302B to aid autonomy computing system 200 in generating predictive drive patterns.

Distinct from autonomous vehicle 100 shown and discussed herein with respect to FIGS. 3A-3E, autonomous vehicle 100 shown in FIG. 4 includes only a single radio frequency receiver 219. More specifically, a single RF receiver 219 is positioned on autonomous vehicle 100 and is in operable communication with autonomy computing system 200. Although a single RF receiver 219 is shown in FIG. 4, it is understood that the single RF receiver 219 can still receive RF signals 310, 318 and allow autonomy computing system 200 to perform similar processes (e.g., signal strength detection) to determine drive characteristics for each received RF signal. By monitoring how the signal strength for each RF signal 310, 318 varies over time compared to vehicles 302 in the vicinity of autonomous vehicle 100, an association can be created between RF signal 310, 318 and the different vehicles 302. When the signal strength increases, vehicles 302 that get closer to receiver 219 are more likely to be the source of the received signal. Alternatively, when the RF signal 310, 318 gets weaker, the vehicles 302 getting further away from receiver 219 are more likely to be the source. This process facilitates associating an object (e.g., vehicle 302) with its history before the object becomes occluded.

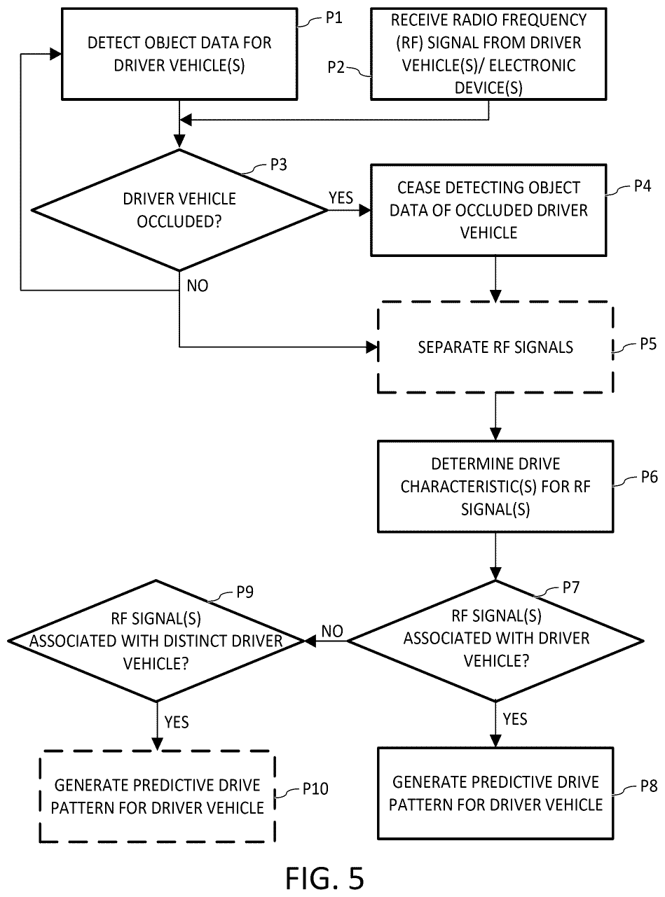

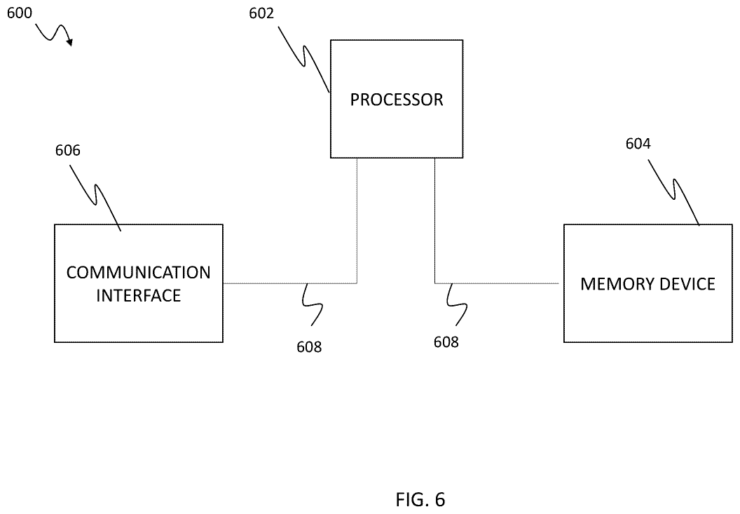

FIG. 5 is an example processes for augmenting the tracking of driver vehicles. Specifically, FIG. 5 shows a flowchart depicting one example process for augmenting the tracking of driver vehicles by generating a predictive drive pattern for a driver vehicle, even after it becomes occluded to the autonomous vehicle. In some cases, the processes can be performed using autonomous vehicle 100, as discussed above with respect to FIGS. 1-4, and autonomy computing system 200 shown and discussed herein with respect to FIGS. 2 and 6.

In process P1, object data for at least one drive vehicle is detected. Object data can be detected, for example, using a plurality of sensors positioned on an autonomous vehicle. Detect object data can include, but is not limited to, a location of the detected driver vehicle(s), a direction of travel for the driver vehicle(s), a speed/acceleration for driver vehicle(s), a size of the driver vehicle(s), a distance between the autonomous vehicle and driver vehicle(s), a make/model of the driver vehicle(s), or any other suitable data that is utilized for facilitating the augmentation of tracking driver vehicles, as discussed herein.

In process P2, at least one radio frequency (RF) signal is received. More specifically, at least one RF signal, emitted by the driver vehicle(s) and/or at least one electronic device included within the driver vehicle(s) is received. In a non-limiting example, the RF signal(s) may be received by at least one radio frequency received positioned on and/or included within the autonomous vehicle. In non-limiting examples, the received RF signals can include, but are not limited to, a driver vehicle-specific radio frequency signal emitted by the driver vehicle, a bluetooth (R) signal emitted by the driver vehicle, a Wi-Fi signal emitted by the driver vehicle, a bluetooth (R) signal emitted by the at least one electronic device, a Wi-Fi signal emitted by the at least one electronic device, a cellular or telecommunication signal emitted by the at least one electronic device, or any other suitable continuous or semi-continuous RF signal. It is understood that the RF signals may be continuously received throughout the processes discussed herein.

In process P3, it is determined if one or more of the detected or sensed driver vehicles has been occluded. For example, has a previously detected driver vehicle (e.g., process P1) become occluded, blocked, non-visible, and/or non-detectable by the sensors of the autonomous vehicle. In response to determining the driver vehicle has not been occluded (e.g., “NO” at process P3), the process may both proceed to process P5, as well as continuously perform process P1 and P2. In response to determining the driver

In process P4, the detection of object data ceases. More specifically, and in response to determining a driver vehicle is occluded, the detection of object data for the occluded driver vehicle ceases. Previously detected object data (e.g., process P1) for the now occluded driver vehicle (e.g., “YES”at process P3) may be utilized in subsequent processes.

In process P5, shown in phantom as optional, radio frequency (RF) signals are separated. That is, when multiple or a plurality of RF signals are received in process P2, the plurality of RF signals may be separated and/or identified individually in process P5. Separating the plurality of RF signals ensure that drive characteristics may be determined for each individual, received RF signal.

In process P6, drive characteristics for each RF signal may be determined. More specifically, each received RF signal in process P2 may have at least one drive characteristic determined, related, and/or established. In a non-limiting example, determining the drive characteristic for each received RF signal can include calculating a position of the received RF signal, calculating a velocity of the driver vehicle or the electronic device emitting the radio frequency signal, and/or calculating a distance between the driver vehicle or the electronic device emitting the RF signal and the autonomous vehicle based on a strength of the RF signal.

In process P7 it is determined if the RF signal(s) is associated with one of the driver vehicles. That is, it is determined if the received RF signal or plurality of signals are associated with one of the detected driver vehicles based on the determined driver characteristics relating to the RF signal (e.g., process P6) and the detected object data for the driver vehicle (e.g., process P1). In a non-limiting example, determining if the RF signal is or can be associated with a detected driver vehicle includes comparing the determined drive characteristics relating to the received RF signal with the detected object data for the driver vehicle, and determining a probability that the received RF signal is emitted by the driver vehicle or emitted by the electronic device positioned within the driver vehicle. In response to the determined probability being equal to or greater than a probability threshold, determining if the RF signal is associated with the driver vehicle also includes validating that the received RF signal is emitted by the driver vehicle or emitted by the electronic device positioned within the driver vehicle (e.g., “YES” at process P7), and the process proceeds to process P8. Otherwise, the process proceeds to process P9 (e.g., “NO”at process P7).

In process P8, a predictive drive pattern for the driver vehicle is generated. More specifically, a predictive drive pattern is generated for the occluded drive vehicle that is associated with the RF signal(s) in process P7. The predictive drive pattern is generated based on the detected object data (e.g., process P1) for the driver vehicle and the determined drive characteristics relating to the received RF signal (e.g., process P6) associated with the driver vehicle. Additionally, because the RF signals associated with the driver vehicle are continuously received, the predictive drive pattern for the driver vehicle may be continuously generated and/or updated to improve the operation and detection of the otherwise occluded driver vehicle by the autonomous vehicle using the predictive drive pattern.

In response to determining the RF signal(s) is not associated with the driver vehicle (e.g., “NO” at process P7), process P9 may be performed. Similar to process P7, it is determined if the received RF signal or plurality of signals are associated with a distinct one of the detected driver vehicles based on the determined driver characteristics relating to the RF signal (e.g., process P6) and the distinct detected object data for the distinct driver vehicle (e.g., process P1). In a non-limiting example, determining if the RF signal is or can be associated with the distinct driver vehicle includes comparing the determined drive characteristics relating to the received RF signal with the distinct detected object data for the distinct driver vehicle, and determining a probability that the received RF signal is emitted by the distinct driver vehicle or emitted by a distinct electronic device positioned within the distinct driver vehicle. In response to the determined probability being equal to or greater than a probability threshold, determining if the RF signal is associated with the distinct driver vehicle includes validating that the received RF signal is emitted by the distinct driver vehicle/distinct electronic device positioned within the distinct driver vehicle (e.g., “YES” at process P9), and the process proceeds to process P10. Otherwise, process P9 repeats itself until it determines which detected driver vehicle can be associated with the received RF signal(s) (e.g., “NO”at process P9).

Similar to process P8, in process P10 a predictive drive pattern for the distinct driver vehicle is generated. More specifically, a predictive drive pattern is generated for the occluded, distinct drive vehicle that is associated with the RF signal(s) in process P9. The predictive drive pattern is generated based on the detected object data (e.g., process P1) for the distinct driver vehicle and the determined drive characteristics relating to the received RF signal (e.g., process P6) associated with the distinct driver vehicle. Additionally, because the RF signals associated with the distinct driver vehicle are continuously received, the predictive drive pattern for the distinct driver vehicle may be continuously generated and/or updated to improve the operation and detection of the otherwise occluded, distinct driver vehicle by the autonomous vehicle using the predictive drive pattern.

FIG. 6 is a block diagram of an example computing device 600. Computing device 600 includes a processor 602 and a memory device 604. The processor 602 is coupled to the memory device 604 via a system bus 608. The term “processor” refers generally to any programmable system including systems and microcontrollers, reduced instruction set computers (RISC), complex instruction set computers (CISC), application specific integrated circuits (ASIC), programmable logic circuits (PLC), and any other circuit or processor capable of executing the functions described herein. The above examples are example only, and thus are not intended to limit in any way the definition or meaning of the term “processor.”

In the example embodiment, the memory device 604 includes one or more devices that enable information, such as executable instructions or other data (e.g., sensor data), to be stored and retrieved. Moreover, the memory device 604 includes one or more computer readable media, such as, without limitation, dynamic random access memory (DRAM), static random access memory (SRAM), a solid state disk, or a hard disk. In the example embodiment, the memory device 604 stores, without limitation, application source code, application object code, configuration data, additional input events, application states, assertion statements, validation results, or any other type of data. The computing device 600, in the example embodiment, may also include a communication interface 606 that is coupled to the processor 602 via system bus 608. Moreover, the communication interface 606 is communicatively coupled to data acquisition devices.

In the example embodiment, processor 602 may be programmed by encoding an operation using one or more executable instructions and providing the executable instructions in the memory device 604. In the example embodiment, the processor 602 is programmed to select a plurality of measurements that are received from data acquisition devices.

In operation, a computer executes computer-executable instructions embodied in one or more computer-executable components stored on one or more computer-readable media to implement aspects of the disclosure described or illustrated herein. The order of execution or performance of the operations in embodiments of the disclosure illustrated and described herein is not essential, unless otherwise specified. That is, the operations may be performed in any order, unless otherwise specified, and embodiments of the disclosure may include additional or fewer operations than those disclosed herein. For example, it is contemplated that executing or performing a particular operation before, contemporaneously with, or after another operation is within the scope of aspects of the disclosure.

An example technical effect of the systems, program products, and methods for augmenting the tracking of driver vehicles for an autonomous vehicle by generating a predictive drive pattern for the driver vehicles, as described herein includes at least one of: (a) improving safety and improved driver vehicle detection for autonomous vehicles during operation (b) allowing autonomous vehicle to monitor and/or estimate a position of an occluded vehicle that would otherwise be undetectable, or (c) reduce processing power or requirements by an internal computing system of the autonomous vehicle while maintaining the ability to track driver vehicles while they are temporarily occluded or not detectable by sensors of the autonomous vehicle.

Some embodiments involve the use of one or more electronic processing or computing devices. As used herein, the terms “processor” and “computer” and related terms, e.g., “processing device,” and “computing device” are not limited to just those integrated circuits referred to in the art as a computer, but broadly refers to a processor, a processing device or system, a general purpose central processing unit (CPU), a graphics processing unit (GPU), a microcontroller, a microcomputer, a programmable logic controller (PLC), a reduced instruction set computer (RISC) processor, a field programmable gate array (FPGA), a digital signal processor (DSP), an application specific integrated circuit (ASIC), and other programmable circuits or processing devices capable of executing the functions described herein, and these terms are used interchangeably herein. These processing devices are generally “configured” to execute functions by programming or being programmed, or by the provisioning of instructions for execution. The above examples are not intended to limit in any way the definition or meaning of the terms processor, processing device, and related terms.

The various aspects illustrated by logical blocks, modules, circuits, processes, algorithms, and algorithm steps described above may be implemented as electronic hardware, software, or combinations of both. Certain disclosed components, blocks, modules, circuits, and steps are described in terms of their functionality, illustrating the interchangeability of their implementation in electronic hardware or software. The implementation of such functionality varies among different applications given varying system architectures and design constraints. Although such implementations may vary from application to application, they do not constitute a departure from the scope of this disclosure.

Aspects of embodiments implemented in software may be implemented in program code, application software, application programming interfaces (APIs), firmware, middleware, microcode, hardware description languages (HDLs), or any combination thereof. A code segment or machine-executable instruction may represent a procedure, a function, a subprogram, a routine, a subroutine, a module, a software package, a class, or any combination of instructions, data structures, or program statements. A code segment may be coupled to, or integrated with, another code segment or an electronic hardware by passing or receiving information, data, arguments, parameters, memory contents, or memory locations. Information, arguments, parameters, data, etc. may be passed, forwarded, or transmitted via any suitable means including memory sharing, message passing, token passing, network transmission, etc.

The actual software code or specialized control hardware used to implement these systems and methods is not limiting of the claimed features or this disclosure. Thus, the operation and behavior of the systems and methods were described without reference to the specific software code being understood that software and control hardware can be designed to implement the systems and methods based on the description herein.

When implemented in software, the disclosed functions may be embodied, or stored, as one or more instructions or code on or in memory. In the embodiments described herein, memory includes non-transitory computer-readable media, which may include, but is not limited to, media such as flash memory, a random access memory (RAM), read-only memory (ROM), erasable programmable read-only memory (EPROM), electrically erasable programmable read-only memory (EEPROM), and non-volatile RAM (NVRAM). As used herein, the term “non-transitory computer-readable media” is intended to be representative of any tangible, computer-readable media, including, without limitation, non-transitory computer storage devices, including, without limitation, volatile and non-volatile media, and removable and non-removable media such as a firmware, physical and virtual storage, CD-ROM, DVD, and any other digital source such as a network, a server, cloud system, or the Internet, as well as yet to be developed digital means, with the sole exception being a transitory propagating signal. The methods described herein may be embodied as executable instructions, e.g., “software” and “firmware,” in a non-transitory computer-readable medium. As used herein, the terms “software” and “firmware” are interchangeable and include any computer program stored in memory for execution by personal computers, workstations, clients, and servers. Such instructions, when executed by a processor, configure the processor to perform at least a portion of the disclosed methods.

As used herein, an element or step recited in the singular and proceeded with the word “a” or “an” should be understood as not excluding plural elements or steps unless such exclusion is explicitly recited. Furthermore, references to “one embodiment” of the disclosure or an “exemplary” or “example” embodiment are not intended to be interpreted as excluding the existence of additional embodiments that also incorporate the recited features. Likewise, limitations associated with “one embodiment” or “an embodiment” should not be interpreted as limiting to all embodiments unless explicitly recited.

Disjunctive language such as the phrase “at least one of X, Y, or Z,” unless specifically stated otherwise, is generally intended, within the context presented, to disclose that an item, term, etc. may be either X, Y, or Z, or any combination thereof (e.g., X, Y, and/or Z). Likewise, conjunctive language such as the phrase “at least one of X, Y, and Z,” unless specifically stated otherwise, is generally intended, within the context presented, to disclose at least one of X, at least one of Y, and at least one of Z.

The disclosed systems and methods are not limited to the specific embodiments described herein. Rather, components of the systems or steps of the methods may be utilized independently and separately from other described components or steps.

This written description uses examples to disclose various embodiments, which include the best mode, to enable any person skilled in the art to practice those embodiments, including making and using any devices or systems and performing any incorporated methods. The patentable scope is defined by the claims and may include other examples that occur to those skilled in the art. Such other examples are intended to be within the scope of the claims if they have structural elements that do not differ from the literal language of the claims, or if they include equivalent structural elements with insubstantial differences form the literal language of the claims.

What is claimed is:

1. A system comprising:
a plurality of sensors positioned on an autonomous vehicle;
at least one radio frequency receiver positioned on the autonomous vehicle; and
at least one autonomous vehicle computing system in electronic communication with the plurality of sensors and the at least one radio frequency receiver, the at least one autonomous vehicle computing system configured to augment tracking of a driver vehicle by performing processes including:
detecting object data for the driver vehicle using the plurality of sensors;
receiving at least one radio frequency signal from at least one of the driver vehicle or at least one electronic device;
determining drive characteristics relating to the at least one received radio frequency signal;
determining if the at least one received radio frequency signal is associated with the driver vehicle based on the determined drive characteristics and the detected object data for the driver vehicle; and
in response to determining the at least one received radio frequency signal is associated with the driver vehicle, generating a predictive drive pattern for the driver vehicle based on the detected object data and the determined drive characteristics relating to the at least one received radio frequency signal.

2. The system of claim 1, wherein the at least one autonomous vehicle computing system is configured to augment the tracking of the driver vehicle by performing further processes including:
in response to the driver vehicle becoming occluded, ceasing the detecting of the object data of the driver vehicle using the plurality of sensors.

3. The system of claim 1, wherein the at least one autonomous vehicle computing system is configured to augment the tracking of the driver vehicle by performing further processes including:
in response to receiving a plurality of radio frequency signals, separating the plurality of received radio frequency signals; and
determining drive characteristics relating to each of the of the plurality of received radio frequency signals.

4. The system of claim 1, wherein the at least one autonomous vehicle computing system is configured to determine the drive characteristics relating to the at least one received radio frequency signal by performing processes including calculating at least one of:
a position of the at least one received radio frequency signal,
a velocity of the driver vehicle or the at least one electronic device emitting the at least one radio frequency signal, or
a distance between the driver vehicle or the at least one electronic device emitting the at least one radio frequency signal and the autonomous vehicle based on a strength of the at least one received radio frequency signal.

5. The system of claim 1, wherein the at least one autonomous vehicle computing system is configured to determine if the at least one received radio frequency signal is associated with the driver vehicle based on the determined drive characteristics and the detected object data for the driver vehicle by performing processes including:
comparing the determined drive characteristics relating to the at least one received radio frequency signal with the detected object data for the driver vehicle;
determining a probability that the at least one received radio frequency signal is emitted by the driver vehicle or emitted by the at least one electronic device positioned within the driver vehicle; and
in response to the determined probability being equal to or greater than a probability threshold, validating the at least one received radio frequency signal is emitted by the driver vehicle or emitted by the at least one electronic device positioned within the driver vehicle.

6. The system of claim 1, wherein the at least one autonomous vehicle computing system is configured to augment the tracking of the driver vehicle by performing further processes including:
in response to determining the at least one received radio frequency signal is not associated with the driver vehicle, detecting distinct object data for a distinct driver vehicle using the plurality of sensors; and
determining if the at least one received radio frequency signal is associated with the distinct driver vehicle based on the determined drive characteristics and the detected distinct object data for the distinct driver vehicle.

7. The system of claim 1, wherein the received at least one radio frequency signal from the driver vehicle or the at least one electronic device includes at least one of:
a driver vehicle-specific radio frequency signal emitted by the driver vehicle,
a bluetooth (R) signal emitted by the driver vehicle,
a Wi-Fi signal emitted by the driver vehicle,
a bluetooth (R) signal emitted by the at least one electronic device,
a Wi-Fi signal emitted by the at least one electronic device, or
a cellular signal emitted by the at least one electronic device.

8. The system of claim 1, wherein the at least one radio frequency receiver includes a single radio frequency receiver or a directional radio frequency receiver array.

9. A computer program product stored on a non-transitory computer-readable storage medium, which when executed by a computing system, augments tracking of a driver vehicle, the computer program product comprising program code for:
detecting object data for the driver vehicle using a plurality of sensors positioned on an autonomous vehicle;
receiving at least one radio frequency signal from at least one of the driver vehicle or at least one electronic device by at least one radio frequency receiver positioned on the autonomous vehicle;
determining drive characteristics relating to the at least one received radio frequency signal;
determining if the at least one received radio frequency signal is associated with the driver vehicle based on the determined drive characteristics and the detected object data for the driver vehicle; and
in response to determining the at least one received radio frequency signal is associated with the driver vehicle, generating a predictive drive pattern for the driver vehicle based on the detected object data and the determined drive characteristics relating to the at least one received radio frequency signal.

10. The computer program product of claim 9, further comprises program code for:
ceasing the detecting of the object data of the driver vehicle using the plurality of sensors in response to the driver vehicle becoming occluded.

11. The computer program product of claim 9, further comprises program code for:
separating a plurality of received radio frequency signals in response to receiving the plurality of radio frequency signals by the at least one radio frequency receiver; and
determining drive characteristics relating to each of the of the plurality of received radio frequency signals.

12. The computer program product of claim 9, wherein the determining of the drive characteristics relating to the at least one received radio frequency signal further includes calculating at least one of:
a position of the at least one received radio frequency signal,
a velocity of the driver vehicle or the at least one electronic device emitting the at least one radio frequency signal, or
a distance between the driver vehicle or the at least one electronic device emitting the at least one radio frequency signal and the autonomous vehicle based on a strength of the at least one received radio frequency signal.

13. The computer program product of claim 9, wherein the determining if the at least one received radio frequency signal is associated with the driver vehicle based on the determined drive characteristics and the detected object data for the driver vehicle further includes:
comparing the determined drive characteristics relating to the at least one received radio frequency signal with the detected object data for the driver vehicle;
determining a probability that the at least one received radio frequency signal is emitted by the driver vehicle or emitted by the at least one electronic device positioned within the driver vehicle; and
in response to the determined probability being equal to or greater than a probability threshold, validating the at least one received radio frequency signal is emitted by the driver vehicle or emitted by the at least one electronic device positioned within the driver vehicle.

14. The computer program product of claim 9, further comprises program code for:
detecting distinct object data for a distinct driver vehicle using the plurality of sensors in response to determining the at least one received radio frequency signal is not associated with the driver vehicle; and
determining if the at least one received radio frequency signal is associated with the distinct driver vehicle based on the determined drive characteristics and the detected distinct object data for the distinct driver vehicle.

15. A method for augmenting tracking of a driver vehicle, the method comprising:
detecting object data for the driver vehicle using a plurality of sensors positioned on an autonomous vehicle;
receiving at least one radio frequency signal from at least one of the driver vehicle or at least one electronic device by at least one radio frequency receiver positioned on the autonomous vehicle;
determining drive characteristics relating to the at least one received radio frequency signal;
determining if the at least one received radio frequency signal is associated with the driver vehicle based on the determined drive characteristics and the detected object data for the driver vehicle; and
in response to determining the at least one received radio frequency signal is associated with the driver vehicle, generating a predictive drive pattern for the driver vehicle based on the detected object data and the determined drive characteristics relating to the at least one received radio frequency signal.

16. The method of claim 15, further comprising:
ceasing the detecting of the object data of the driver vehicle using the plurality of sensors in response to the driver vehicle becoming occluded.

17. The method of claim 15, further comprising:
separating a plurality of received radio frequency signals in response to receiving the plurality of radio frequency signals by the at least one radio frequency receiver; and
determining drive characteristics relating to each of the of the plurality of received radio frequency signals.

18. The method of claim 15, wherein the determining of the drive characteristics relating to the at least one received radio frequency signal further includes calculating at least one of:
a position of the at least one received radio frequency signal,
a velocity of the driver vehicle or the at least one electronic device emitting the at least one radio frequency signal, or
a distance between the driver vehicle or the at least one electronic device emitting the at least one radio frequency signal and the autonomous vehicle based on a strength of the at least one received radio frequency signal.

19. The method of claim 15, wherein the determining if the at least one received radio frequency signal is associated with the driver vehicle based on the determined drive characteristics and the detected object data for the driver vehicle further includes:
comparing the determined drive characteristics relating to the at least one received radio frequency signal with the detected object data for the driver vehicle;
determining a probability that the at least one received radio frequency signal is emitted by the driver vehicle or emitted by the at least one electronic device positioned within the driver vehicle; and
in response to the determined probability being equal to or greater than a probability threshold, validating the at least one received radio frequency signal is emitted by the driver vehicle or emitted by the at least one electronic device positioned within the driver vehicle.

20. The method of claim 15, further comprising:
detecting distinct object data for a distinct driver vehicle using the plurality of sensors in response to determining the at least one received radio frequency signal is not associated with the driver vehicle; and
determining if the at least one received radio frequency signal is associated with the distinct driver vehicle based on the determined drive characteristics and the detected distinct object data for the distinct driver vehicle.
